(19) United States
(12) Patent Application Publication
(10) Pub. No.: US 2023/0302551 A1
(43) Pub. Date: Sep. 28, 2023

(54) HOLE SAW WITH EJECTOR

(71) Applicant: Mike BENNETT, LOGAN, UT (US)

(72) Inventor: Mike BENNETT, LOGAN, UT (US)

(21) Appl. No.: 18/124,345

(22) Filed: Mar. 21, 2023

Related U.S. Application Data
(60) Provisional application No. 63/322,452, filed on Mar. 22, 2022.

(51) Int. Cl. B23B 51/04

(52) U.S. Cl. CPC B23B 51/0453; B23B 51/0426

(57) ABSTRACT

A hole saw with ejector configured to eject a plug upon rotating a collar located about the cutting blade. The hole saw with ejector has an annular cutting blade with one or more slots angled with respect to a longitudinal axis. The ejector forms a sub-assembly with a plug stop located inside the cutting blade, an ejector collar located about the cutting blade, and one or more attachments through the one or more slots that connect the plug stop to the ejector collar and form a track and/or rail system whereupon rotation of the ejector collar moves the sub-assembly backward and forward to eject a sawn plug from the hole saw.

### RELATED APPLICATION

This application is the non-provisional application of United States provisional application number 63,322,452, filed on Mar. 22, 2022, and claims priority thereto.

### BACKGROUND OF THE INVENTION

Hole saws are used to cut precise holes in different types of applications, ranging from bathroom basins to external walls. A hole saw is typically a saw blade of annular shape that creates a hole in a workpiece without having to cut up the core material. Hole saws often have a pilot drill bit at their center to keep the saw teeth from walking. Hole saws may used with a powered drill. The cut material typically forms a plug.

Although they are very useful for the purpose of cutting holes into material, hole saws also have some inherent disadvantages. For example, the plug often binds tightly inside the hole saw. Often, it must be laboriously pried out after each hole is cut. Sometimes the prying is quite difficult. On occasion, the core plug will even twist apart mid-cut, creating a condition where the core inside the hole saw spins on the yet-uncut portion of the core still in the workpiece. This condition tends to stop the cutting action of the saw. If the workpiece is wood or plastic, the friction from this condition will start to singe the workpiece, creating an unpleasant burning smell and heating up the hole saw considerably. The twisted-off core must then be pried out of the hole saw, again, with much difficulty, before the cutting can continue. This is merely one example of the issues and problems presented by traditional hole saws.

Various attempts have been made to lessen the difficulty of removing a plug from the hole saw. For example, screwdrivers (or similar tools) can be inserted into the open front of a hole saw and attempts made to pry the plug from the hole saw. Some hole saws incorporate apertures formed into the side of the saw blade in order to provide additional access/pry points for, for example, a screwdriver, in the effort to remove the plug. However, even if the hole saw has additional access/pry points, prying a difficult plug from a hole saw with a screwdriver is less than optimal—not only because it is unwieldy—but because it may present safety issues presented by combining pointed screwdriver ends with slipped grips and user body parts like hands and fingers.

In another example of an attempt to address the problem, some hole saw designs incorporate an internal spring intended to push the plug out of the hole saw after the cut is completed. However, these designs also have drawbacks. In particular, the force provided by a hole saw internal spring is quite limited and often insufficient to eject a stubborn plug. Moreover, internal springs (and attendant components) in the hole saw are vulnerable to breakage from forces within the hole saw environment. Again, broken parts and components may present safety issues in a powered tool environment.

In other examples, hole saw designs incorporate series of sequential mechanisms, (e.g., screw-type, etc.) that result in a highly elongated arbor. Of course, while this may provide for a better mechanism to remove a plug than some previous designs, the overall functionality of the hole saw is reduced by virtue of an unwieldy, highly elongated arbor, instead of the traditionally compact and easy to control type. Moreover, because the mechanisms are sequentially connected, the plug ejector component is susceptible to locking tightly from counterforces from the hole saw component, thus defeating the purpose of an easy to use ejector.

Given the ongoing problems of removing plugs from hole saws, and the drawbacks of the solutions attempted to date, new designs with additional functionality are needed. In particular, a better design would address and resolve the problems of, for example, insufficient plug access and removal force required to safely remove plugs from a hole saw, while also maintaining the relative control and ease of use of traditional hole saws.

### SUMMARY OF THE INVENTION

In accordance with the above, a new and innovative hole saw with ejector is provided. The problems of plug access and removal force to safely remove plugs from a hole saw are solved. Embodiments of the present invention include a hole saw with ejector comprising: (1) an annular cutting blade with first and second slots angled with respect to a longitudinal axis of the cutting blade; and (2) an ejector comprising (a) a plug stop located inside the cutting blade and (b) an ejector collar located about the cutting blade, the plug stop attached to the ejection collar by a first attachment that extends through the first slot and a second attachment that extends through the second slot. From the resulting structure, the ejector is rotatable to eject a plug from the hole saw.

These and other aspects of the present invention will become more fully apparent from the following description and appended claims, or may be learned by the practice of the invention as set forth hereinafter.

### BRIEF DESCRIPTION OF THE FIGURES

To further clarify the above and other aspects of the present invention, a more particular description of the invention will be rendered by reference to specific embodiments thereof which are illustrated in the appended drawings. It is appreciated that these drawings depict only exemplary and/or typical embodiments of the invention and are therefore not to be considered limiting of its scope. The drawings may not be drawn to scale. The invention will be described and explained with additional specificity and detail through the use of the accompanying drawings in which:

FIG. 1 is a perspective view of one embodiment of a hole saw with ejector.

FIG. 2 is a first side view of one embodiment of a hole saw with ejector.

FIG. 3 is a second side view of one embodiment of a hole saw with ejector.

FIG. 4 is a front view of one embodiment of a hole saw with ejector.

FIG. 5 is a first side view of one embodiment of a hole saw with ejector in a first position and a plug inside the hole saw.

FIG. 6 is a first side view of one embodiment of a hole saw with ejector in a second position and a plug ejected from the hole saw.

### DETAILED DESCRIPTION OF THE ILLUSTRATED EMBODIMENT

The present invention in its various embodiments, some of which are depicted in the figures herein, is a hole saw with ejector.

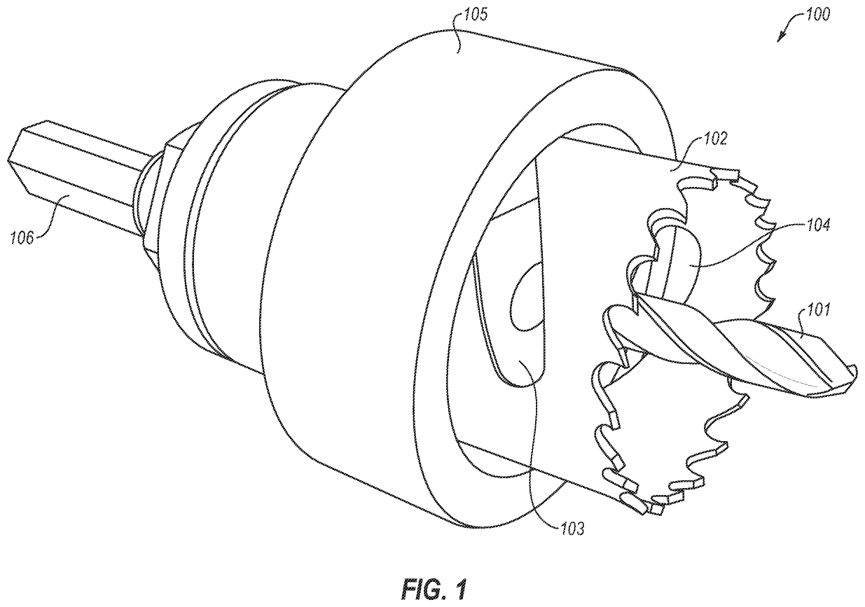

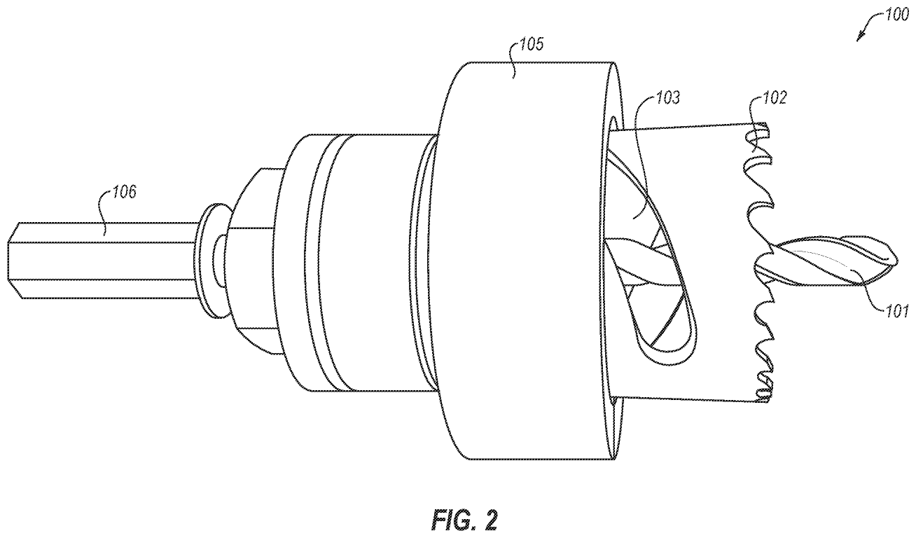

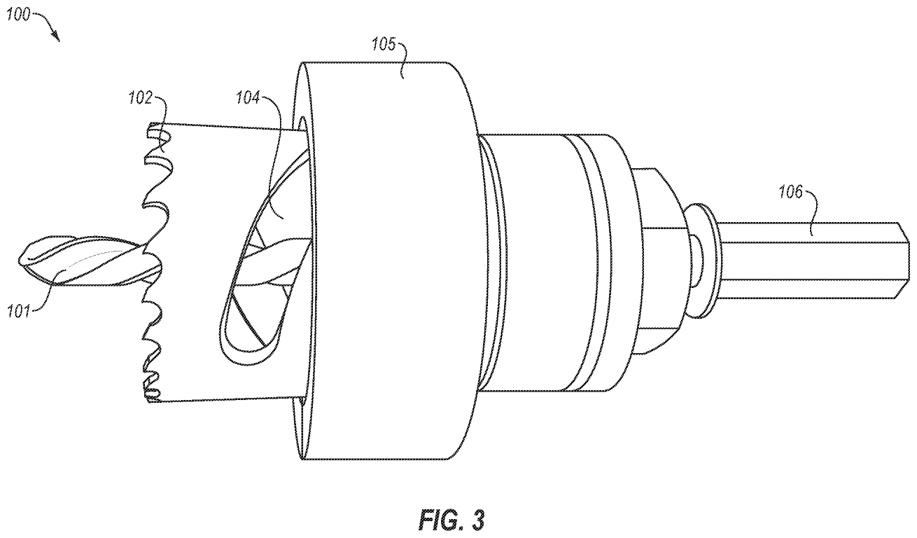

Referring now to FIGS. 1-4, one embodiment of a hole saw with ejector 100 is shown. Hole saw with ejector 100 comprises a main assembly with, at a first end, a pilot bit 101 centrally located within an annular cutting blade 102. The annular cutting blade 102 is connected to a rotatable ejection collar 105 configured for ejecting sawn plugs. In the illustrated embodiment, rotatable ejection collar 105 may be generally located at a middle portion of the main assembly, but repositionable with respect to, for example, the annular cutting blade 102 and pilot bit 101, as the ejection collar 105 is rotated by a user, as discussed in more detail below. The annular cutting blade 102 and rotatable ejection collar 105 are attached to an arbor 106 located at a second end of the main assembly.

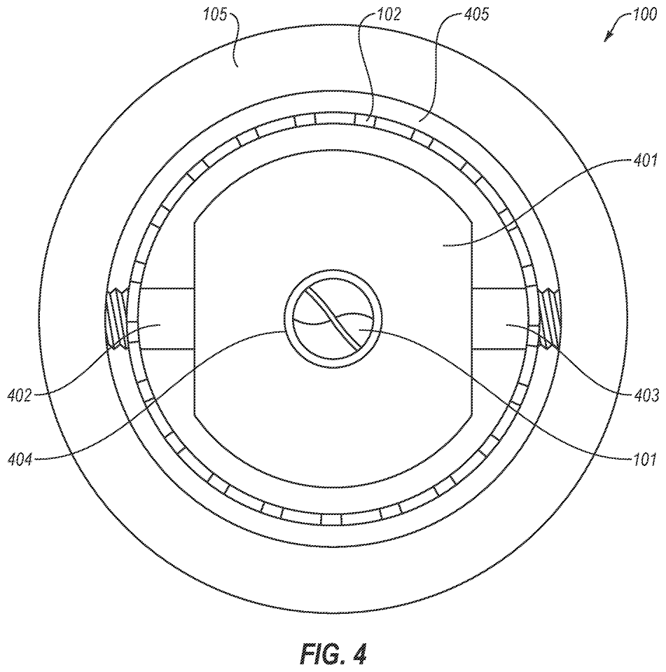

Annular cutting blade 102 has one or more sides having a first elongate slot 103 and a second elongate slot 104. In the illustrated embodiment, slots 103, 104 are angled with respect to ends of the cutting blade 102 (and/or a longitudinal axis of the main assembly) and may be opposingly located with respect to each other or on opposite sides of the annular cutting blade 102. Referring now to FIG. 4, the main assembly further includes a plug stop member 401 located inside of the annular cutting blade 102. Plug stop member 401 may be suspended inside of the annular cutting blade 102 and attached to the rotatable ejection collar 105 through the slots 103, 104 by a first plug stop attachment 402 disposed through the first elongate slot 103 and a second plug stop attachment 403 disposed through the second elongate slot 104.

In the illustrated embodiment, rotatable ejection collar 105, plug stop member 401, and plug stop attachments 402, 403 form a sub-assembly of the main assembly. The components of the sub-assembly move together in relation to the other components of the main assembly. More particularly, the sub-assembly rotates about and/or within, for example, the annular cutting blade 102, along a fixed track and/or rail system formed by the slots 103, 104 and plug stop attachments 402, 403.

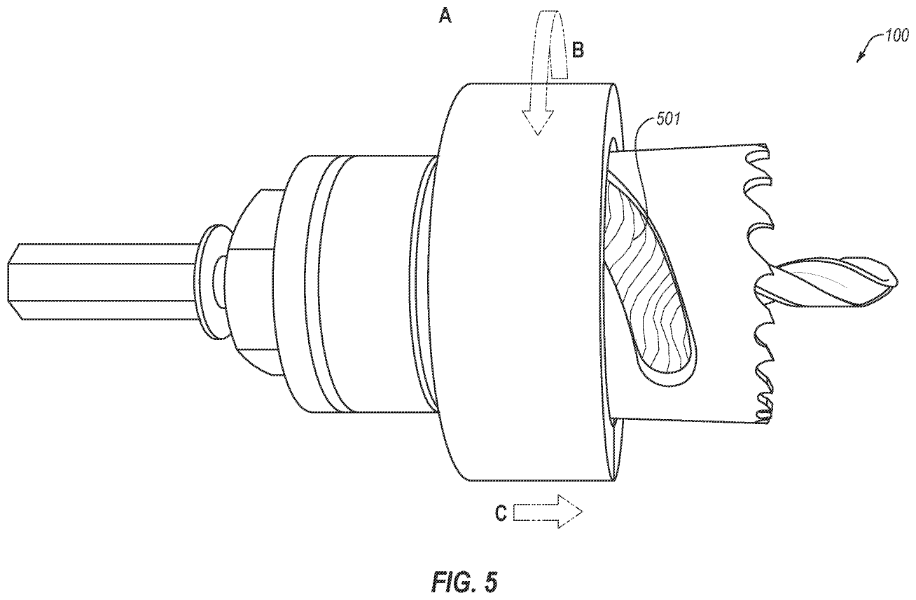

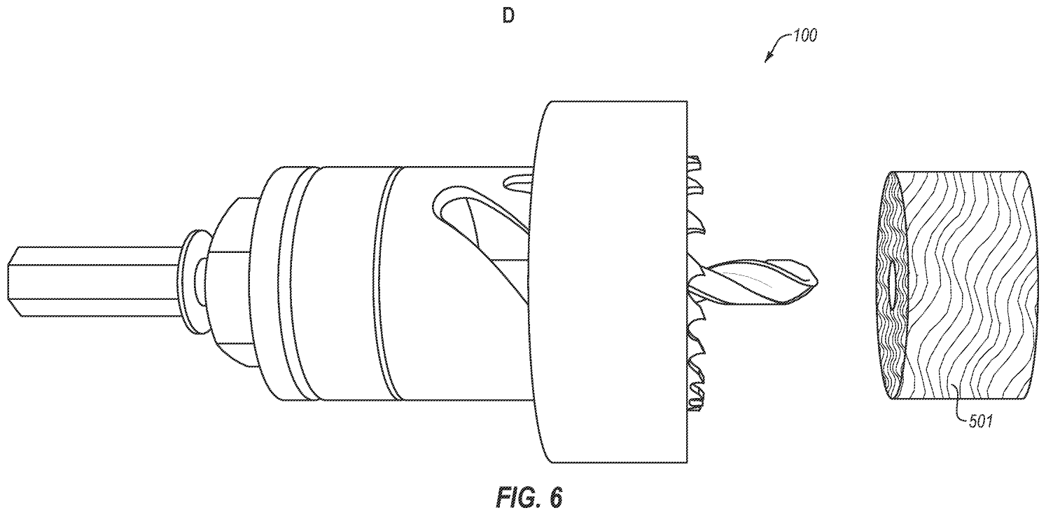

Referring now to FIGS. 5 and 6, the hole saw with ejector 100 is shown with the sub-assembly (comprised of the rotatable ejection collar 105, plug stop member 401, and plug stop attachments 402, 402) in a first position A wherein it is located at a rearmost position with respect to the slots 103, 104. So positioned, the annular cutting blade 102 is exposed and shown with a plug of material 501 that has been previously removed by the hole saw 100. The cut plug of material 501 is located in front of, and abuts, the plug stop member 401.

In operation, a user removes the plug of material 501 by using his or her hand to rotate the rotatable ejection collar 105 in direction B. As the rotatable ejection collar 105 is rotated in direction B, the plug stop attachments 402, 403 are forced to travel within corresponding slots 103, 104. Because slots 103, 104 are angled, the sub-assembly is forced forward on the track and/or rail system in direction C as the rotatable ejection collar 105 is rotated. Consequently, plug stop member 401 is thereby driven forward in direction C, forcing the plug of material 501 out of an open end of the hole saw with ejector 100. The sub-assembly has a second position D (see FIG. 6) wherein it is located at a forwardmost position with respect to the slots 103, 104, having ejected the plug of material 501.

So configured, the hole saw with ejector 100 solves several problems in the art. First, by having an integrated ejection means, the hole saw with ejector 100 solves the traditional awkwardness, inefficacy, and resulting dangers of using a screwdriver or other tool from the outside to try to pry the plug out of the saw blade through, for example, saw blade apertures. Second, the problem of weak plug ejection derived from internal spring ejection systems is solved with an improved mechanism that translates human hand rotational force/torque to linear force to eject material from the hole saw. Third, the fragility inherent to hole saw internal spring ejection systems, with their more delicate and/or complex mechanisms, is solved by using parts with larger mass (e.g., ejection collar, plug stop member, and plug stop member attachments) within a robust track system. Fourth, because the ejection collar goes around the blade, the means for ejecting the plug does not require an elongation of the overall assembly which would decrease the compactness and ease of use of the hole saw. Fifth, because the counterforces from the hole saw are stopped a the rail and track system instead of a sequential screw-type system, locking of the mechanism is prevented and the design maintains ready ejection without applying undue force to break a locked mechanism.

The present invention may be embodied in other specific forms without departing from its spirit or essential characteristics. The described embodiments are to be considered in all respects only as illustrative and not restrictive. For example, the slots of the hole saw and/or the ejection collar could be configured to achieve similar mechanism to those described herein by being of different shapes and/or having opposite or different rotational movements. The scope of the invention is, therefore, indicated by the appended claims rather than by the foregoing description. All changes which come within the meaning and range of equivalency of the claims are to be embraced within their scope.

I claim:

1. A hole saw with ejector comprising:
an annular cutting blade; and
an ejector attached to the annular cutting blade, the ejector including
a ring located about the annular cutting blade and
a plug stop located inside the annular cutting blade,
wherein the hole saw with ejector is configured to eject a plug when the ring is rotated with respect to the annular cutting blade.

2. The hole saw with ejector of claim 1, the ejector further having an attachment member generally located between the ring and the plug stop, the attachment member configured to attach the ring to the plug stop.

3. The hole saw with ejector of claim 1, the ejector further having two or more attachment members generally located between the ring and the plug stop, the two or more attachment members configured to attach the ring to the plug stop.

4. The hole saw with ejector of claim 2, the annular cutting blade having an angled slot through which the attachment member connects the ring and the plug stop.

5. The hole saw with ejector of claim 3, the annular cutting blade having two angled slots through which the attachment members connect the ring and the plug stop.

6. The hole saw with ejector of claim 4, the ring and plug stop configured to move one or more of back and forth together with respect to the annular cutting blade when the ring is rotated with respect to the annular cutting blade.

7. The hole saw with ejector of claim 5, wherein the attachment members and angled slots form a rail system upon which the ring and plug stop travel.

8. A hole saw with ejector comprising:
an annular cutting blade having
a first angled slot and
a second angled slot located opposite the first angled slot; and
an ejector attached to the annular cutting blade, the ejector including
a ring located about the annular cutting blade,
a plug stop located inside the annular cutting blade, the plug stop connected to the ring through the first and second angled slots,
a first attachment member generally disposed within the first angled slot and between the ring and the plug stop, the first attachment member configured to attach the ring to the plug stop, and
a second attachment member, opposite the first attachment member, generally disposed within the second angled slot and between the ring and the plug stop, the second attachment member configured to attach the ring to the plug stop,
wherein the hole saw with ejector is configured to eject a plug when the ring is rotated with respect to the annular cutting blade.

9. The hole saw with ejector of claim 8, wherein the first and second attachment members and first and second angled slots form a rail system upon which the ring and plug stop travel.

10. The hole saw with ejector of claim 8, the ring and plug stop configured to move one or more of back and forth together with respect to the annular cutting blade when the ring is rotated with respect to the annular cutting blade.

11. The hole way with ejector of claim 8, the ring, first and second attachment members, and plug stop generally all coplanar.

12. A hole saw with ejector comprising:
an annular cutting blade having
a first angled slot and
a second angled slot located opposite the first angled slot; and
an ejector attached to the annular cutting blade, the ejector including
a ring located about the annular cutting blade,
a plug stop located inside the annular cutting blade, the plug stop connected to the ring through the first and second angled slots,
a first attachment member generally disposed within the first angled slot and between the ring and the plug stop, the first attachment member configured to attach the ring to the plug stop, and
a second attachment member, opposite the first attachment member, generally disposed within the second angled slot and between the ring and the plug stop, the second attachment member configured to attach the ring to the plug stop;
wherein the first and second attachment members and first and second angled slots form a rail system within which the ring and plug stop travel;
wherein the ring and plug stop configured to move one or more of back and forth together with respect to the annular cutting blade when the ring is rotated with respect to the annular cutting blade; and
wherein the hole saw with ejector is configured to eject a plug when the ring is rotated with respect to the annular cutting blade.
